(19) United States
(12) Patent Application Publication
(10) Pub. No.: US 2024/0393465 A1
(43) Pub. Date: Nov. 28, 2024

(54) FIRST ARRIVAL DIFFERENTIAL LIDAR

(71) Applicants: William Marsh Rice University, Houston, TX (US); Cornell University, Ithaca, NY (US)

(72) Inventors: Ashok Veeraraghavan, Houston, TX (US); Al Molnar, Ithaca, NY (US); Mel White, Houston, TX (US); Tianyi Zhang, Houston, TX (US); Akshat Dave, Houston, TX (US); Ankit Raghuram, Houston, TX (US); Shahaboddin Ghajari, Ithaca, NY (US)

(73) Assignees: William Marsh Rice University, Houston, TX (US); Cornell University, Ithaca, NY (US)

(21) Appl. No.: 18/676,223

(22) Filed: May 28, 2024

Related U.S. Application Data
(60) Provisional application No. 63/504,662, filed on May 26, 2023.

(51) Int. Cl. G01S 17/894; G01S 7/481; G01S 7/4863; G01S 17/42

(52) U.S. Cl. CPC G01S 17/894; G01S 7/4863; G01S 17/42; G01S 7/4817

(57) ABSTRACT

A digital image detection apparatus and method of use are disclosed. The apparatus may include an array of photon detectors, configured to receive photons reflected from a target scene and a plurality of first arrival differential (FAD) units, where each FAD units is configured to receive a first input from a first photon detector in the array and a second input from a second photon detector. Each FAD unit may include a set-reset (“SR”) latch, configured to receive the first input and the second input and to determine which of the first input and the second input arrives earlier in time, and a counter control unit, configured to receive an output from the SR latch and increment a differential count based on the output.

### CROSS REFERENCE TO RELATED APPLICATIONS

This application claims priority to U.S. Provisional Application Ser. No. 63/504,662, filed May 26, 2023, entitled “First Arrival Differential Lidar,” hereby incorporated herein by reference.

### FEDERAL FUNDING PARAGRAPH

This invention was made with government support under Grant No. 1730574 awarded by the National Science Foundation. The government has certain rights in the invention.

### BACKGROUND

Three-dimensional (“3D”) imaging is important in a wide range of applications, including autonomous vehicles, robotics, entertainment, augmented reality, and virtual reality. Light detection and ranging (“LiDAR”) is a popular choice for many of these applications due to its speed and sensitivity. LiDAR encompasses a class of active 3D imaging methods that uses an emitted pulse of light, typically from a laser, and measures phase shifts or time-lags of light signals reflected from a target scene. A variety of characteristics of the target may be inferred from the phase shifts, such as the relative distance to points in the target scene and the spatial orientation of surfaces within the target scene.

Single-photon avalanche diode (“SPAD”) based LiDAD uses two-dimensional (“2D”) arrays of detectors and flash-based illumination and is a popular choice for many applications, in part because it avoids the necessity for moving mechanical parts required by other scanning base methods. However, current SPAD based LiDAR systems suffer from low resolution due to the relatively high proportion of chip area occupied by the in pixel circuitry required to generate and store photon travel times. This low resolution limitation is compounded by the high data throughput rates required. Consequently, there is a need for a design and method of use for a higher resolution SPAD based 3D image detection apparatus.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a digital image detection apparatus, including an array of photon detectors, configured to receive photons reflected from a target scene, and a plurality of first arrival differential (FAD) units, where each FAD units is configured to receive a first input from a first photon detector in the array and a second input from a second photon detector. Each FAD unit may include a set-reset (“SR”) latch, configured to receive the first input and the second input and to determine which of the first input and the second input arrives earlier in time, and a counter control unit, configured to receive an output from the SR latch and increment a differential count based on the output.

In general, in one aspect, embodiments relate to a system including a light source, configured to illuminate a target scene with a transitory pulse of photons, a digital image detection apparatus and a computer processor. The digital image detection apparatus includes an array of photon detectors, configured to receive photons reflected from the target scene and a plurality of first arrival differential (FAD) units. Each FAD unit is configured to receive a first input from a first photon detector in the array and a second input from a second photon detector, and where, each FAD unit includes a set-reset (“SR”) latch, configured to receive the first input and the second input and to determine which of the first input and the second input arrives earlier in time, a counter control unit, configured to receive an output from the SR latch and increment a differential count based on the output. The computer processor is configured to form an image based on the output of the counter control unit of the plurality of FAD units.

In general, in one aspect, embodiments relate to a method. The method includes illuminating, using a light source, a target scene with plurality of transitory pulses of photons and, for each of the transitory pulses detecting, using a digital image detection apparatus, photons reflected from the target scene. The digital image detection apparatus, includes an array of pairs of photon detectors, configured to receive photons reflected from a target scene, and for each pair of photon detector in the array of pairs of photon detectors; the digital image detection apparatus determines, using a first arrival differential (FAD) unit, an arrival time difference between a first photon detector in the pair and a second a second photon detector in the pair, and updating a differential count for the pair based on the arrival time difference. The method further includes forming, using a computer processor, an image based on the updated differential count for each of the plurality of pairs.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF THE DRAWINGS

Other aspects and advantages of the claimed subject matter will be apparent from the following description and the appended claims.

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1A depicts a schematic configuration of apparatus in accordance with one or more embodiment;

FIG. 1B depicts idealized outputs in accordance with one or more embodiment;

FIG. 2A depicts schematic histograms in accordance with one or more embodiment;

FIG. 2B depicts schematic histograms from a conventional system;

FIG. 2C shows cumulative counts in accordance with one or more embodiment;

FIG. 3 depicts electronic circuitry in accordance with one or more embodiment;

FIGS. 4A-4C illustrate the spatial footprints in accordance with one or more embodiment;

FIGS. 4D-4E show a micrograph of a chip in accordance with one or more embodiment;

FIGS. 5A-5C display electronic circuitry in accordance with one or more embodiment;

FIGS. 6A and 6B display clock circuitry and timing pulses in accordance with one or more embodiment;

FIG. 7A shows experimental apparatus in accordance with one or more embodiment;

FIGS. 7B-7C show experimental results in accordance with one or more embodiment;

FIG. 7D shows experimental apparatus in accordance with one or more embodiment;

FIG. 7E shows experimental results in accordance with one or more embodiment;

FIG. 8A shows results in accordance with one or more embodiment;

FIG. 8B shows a comparison of results obtained by a disclosed embodiment with results obtained from a convention LiDAR system;

FIGS. 9A and 9B illustrate the effect of pulse power in accordance with one or more embodiment;

FIGS. 10A and 10B illustrate the effect of albedo variation in accordance with one or more embodiment;

FIGS. 11A and 11B illustrate the effect background variation without albedo variation in accordance with one or more embodiment;

FIGS. 12A and 12B illustrate the effect background variation with albedo variation in accordance with one or more embodiment;

FIG. 13 depicts a target scene and apparatus arrangement in accordance with one or more embodiment;

FIG. 14 shows target scenes and results arrangement in accordance with one or more embodiment;

FIG. 15 shows results in accordance with one or more embodiment;

FIG. 16 displays a comparison of results of three conventional flash LiDAR systems and embodiments disclosed herein;

FIG. 17 displays trade-offs for conventional flash LiDAR systems and of embodiments disclosed herein;

FIGS. 18A-18B illustrates advantages of embodiments disclosed herein;

FIG. 19 compares intensity reconstruction in accordance with one or more embodiments;

FIG. 20 shows a computer system in accordance with one or more embodiments;

FIG. 21 depicts a flowchart in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

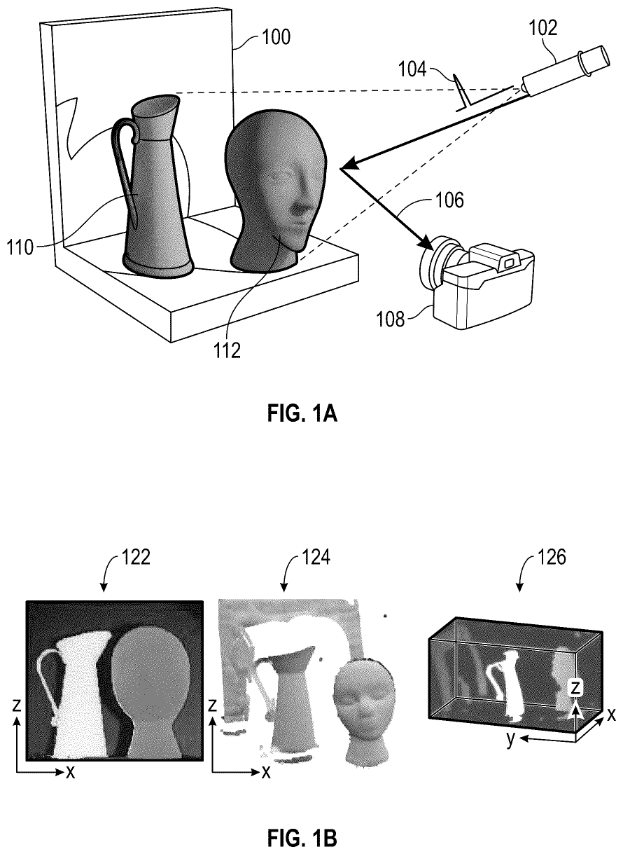

In the following description of FIGS. 1-21, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Single-photon avalanche diode (SPAD) based LiDAR is a common choice for 3D imaging in many emerging applications. However, SPAD based LiDAR suffers from three significant limitations: (a) the additional time-of-arrival dimension results in a data throughput bottleneck, (b) limited spatial resolution due to either low fill-factor (flash LiDAR) or scanning time (scanning-based LiDAR), and (c) coarse depth resolution due to quantization of photon timing by existing SPAD timing circuitries. Embodiments herein disclose a novel method and in-pixel computing architecture termed first arrival differential (“FAD”) LiDAR, where rather than recording quantized time-of-arrival information at individual pixels, a temporal differential measurement between pairs of pixels is determined. FAD captures relative order of photon arrivals at the two pixels (within a cycle or laser period) and creates a one-to-one mapping between this differential measurement and depth differences between the two pixels. As herein disclosed, FAD pixels can produce a 10-100× reduction in per-pixel data throughput compared to time-to-digital (“TDC”)-based pixels. Under the same bandwidth constraints, FAD-LiDAR achieves better depth resolution and/or range than several state-of-the-art TDC-based LiDAR baselines.

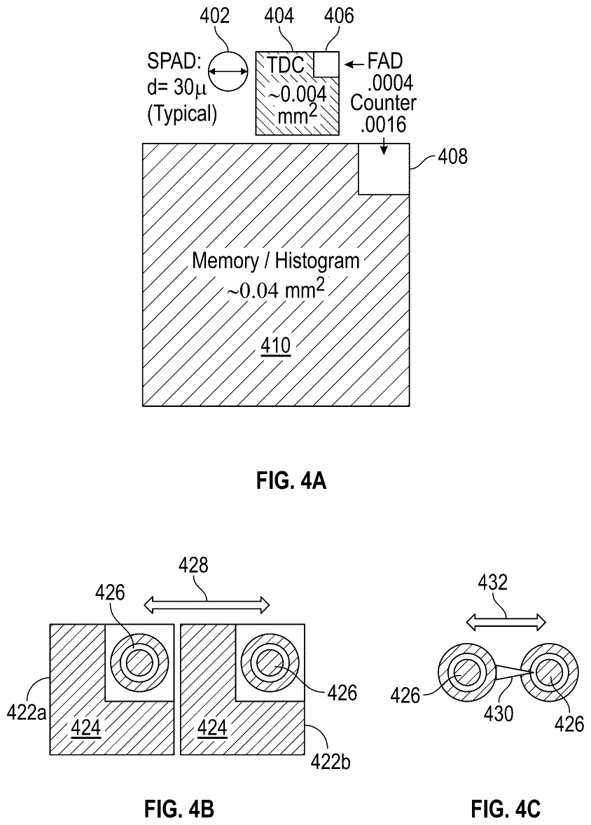

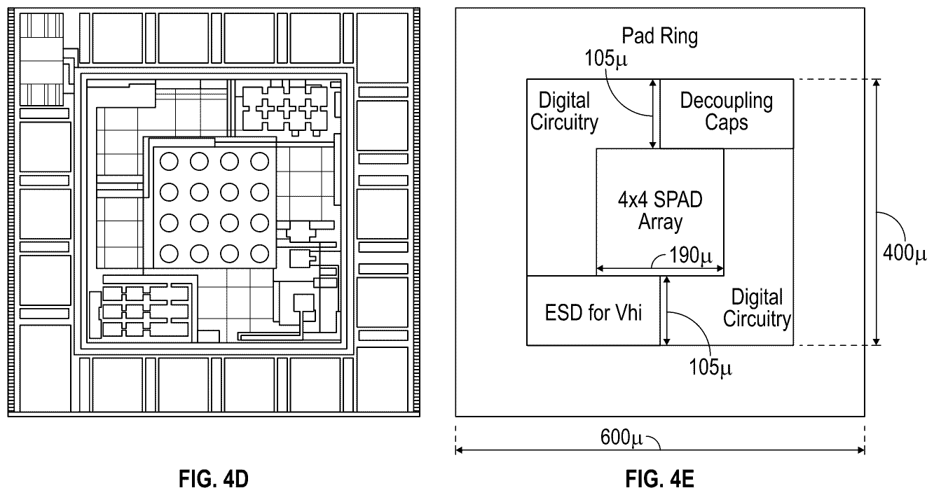

Thus, disclosed designs address the throughput bottleneck in conventional sensors that record time-of-arrival statistics (such as histograms or raw arrival-time data) directly. In addition, these designs also mitigate saturation at the pixel level and at the counter, making it an ideal candidate for use when the scene being imaged covers a high dynamic range. The differential nature of the recorded data also obviates the need for large digital circuitry such as high bit depth counters or time to digital converters (TDCs). An exemplary design featuring 16 pixels, fabricated on a 0.18 μm CMOS, are herein disclosed (see FIGS. 4A-4B) together with experimental images obtained with this chip, illustrating the capabilities of the present apparatus, system and method.

FIG. 1A illustrates an example of the use of a LiDAR to interrogate a 3D target scene (100). The LiDAR system may include a pulsed light source (102), such as a pulsed laser beam, that emits a transitory pulse of light (104) towards the target scene (100) from which it is reflected as a reflected pulse (106). The reflected pulse (106) may then be detected using a sensor (108), that may include a 2D array of detectors. In accordance with one or more embodiments, these detectors may each include a SPAD and the SPADs may be coupled together with FAD units as described in more detail below. The sensor (108) may further include a lens positioned between the target scene (100) and the 2D array of detectors and this lens may be configured to focus the reflected pulse (106) on the 2D array of detectors.

In the example shown in FIG. 1A the target scene includes a liquid container (110) and a model of a human head (112). In other examples, the elements of the target scene may include any number of 3D objects encountered in everyday life including, without limitation, automobiles, bicycles, trees, buildings, furniture, human beings, etc. Thus, the elements of the target scene shown in FIG. 1A are purely illustrative and are not intended to limit the scope of the invention in any way. The elements of the target scene may in general occupy 3D space and have a vertical position (z), a lateral position (x) and a depth (y). Thus, the characteristic of any point in the target scene may include a position and an orientation, for example as indicated by the direction of the normal to the surface of which the point is a member. Further characteristic may include the positions of boundaries between surfaces in the target scene. These boundaries may be indicated by discontinuities in one or more position coordinates (x, y, z) between adjacent points and/or a discontinuity in the normal to the surface between adjacent points.

By way of example, FIG. 1B illustrates some of these characteristics. Chart (122) illustrates a depth map, with small depths depicted in red, intermediate depths depicted in green, and large depths depicted in blue. Similarly, chart (124) illustrates a surface orientation map and chart (126) illustrating 3D position.

The reflected pulse of light may be considered to be composed of a stream of photons. When such a pulse of light falls on an object the photons may be scattered while maintaining the frequency and phase of the incident photon. Such photons may properly be call reflected photons. However, incident photons may also be absorbed by the object and subsequently new photons of the same or a different frequency readmitted. Herein, both properly reflected photons and readmitted photons will be collectively termed “reflected photons”.

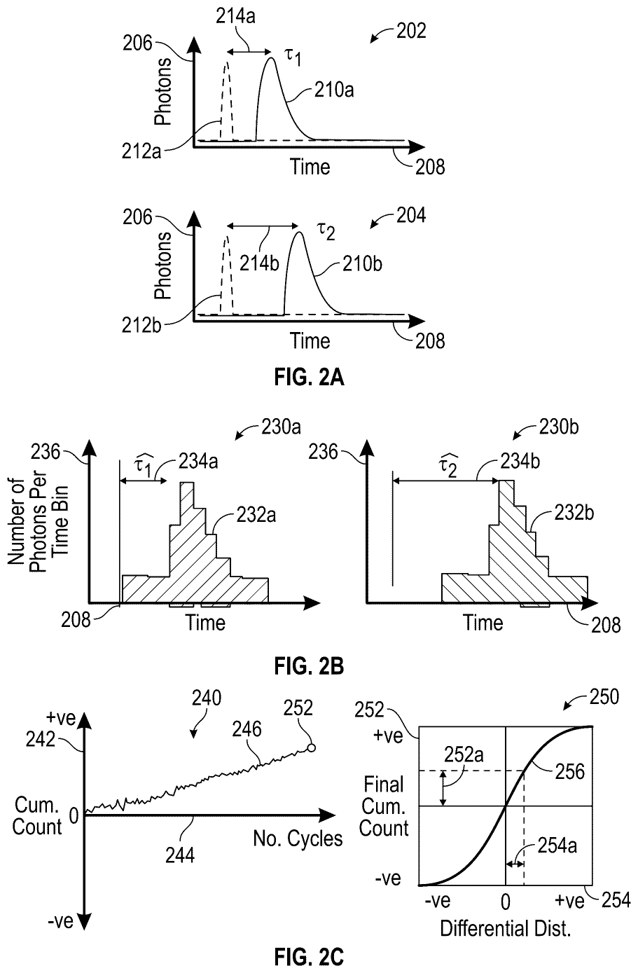

FIG. 2A show graphs of the number of reflected photons arriving at two detectors in the 2D array of detectors as a function of time after the activation of the transient light source. The chart (202) indicates the detected photons for a first detector and the chart (204) indicates the detected photons for a second detector. In each case the vertical axis (206) indicates the number of detected photons per unit time, while the horizontal axis (208) indicates time. The numbers of photons detected per unit time are indicated by the lines (210a) and (210b) and the time of activation of the transient light source are indicated by the spikes (212a) and (212b). The numbers of photons detected per unit time may be the number of photons detected summed over many cycles of sequential activation the transitory light source.

The two detectors depicted in FIG. 2A may be adjacent to one another in space and each of the two detectors may include a SPAD. The peak of the lines indicating the numbers of photons detected per unit time may indicate an average travel time, such as travel times (214a) and (214b), of reflected photons at the corresponding detector. The average travel times may be indicative of the distance between the detector and a corresponding point in the target scene. For example, for the first detector the first average travel time (214a) may indicate the distance from the first detector to a first point in the target scene, while for the second detector the second average travel time (214b) may indicate the distance from the second detector to a second point in the target scene. Similarly, the difference between the first average travel time (214a) and the second average travel time (214b) may be related to the relative position of corresponding reflection points of the photons within the target scene.

It may be noted that the lines (210a) and (210b) are characterized by peaks of a finite width rather than a sharp delta-function (“spike”) indicating that reflected photons have been detected with apparent travel times both less than, and greater than, the travel time associated with the peak of the curve. This distribution of apparent travel times may be the result of many causes including, without limitation, a finite duration of the original emitted transitory pulse, multiple scattering of photons within the scene, refraction of the photon as it passes through the air between the target scene and the light source and the sensor, and motion, such as vibration of objects within the target scene.

A conventional approach to determining the difference between the average times of two detectors, such as SPADs, is illustrated in FIG. 2B. For each activation of the transient light source (102) the travel time of the first photon to reach the detector is recorded the travel time is added to a time “bin” enclosing the travel time. A histogram is constructed from the travel times recorded from multiple activations of the transient light source. Such a histogram for a first detector is depicted in chart (230a) and for a second detector in chart (230b). In both chart (230a) and (230a) the number of photons recorded per time bin for many activations of the transient light source is indicated on the vertical axis (236). The horizontal axis may indicate a central travel time of each of the time bins. As an example, the transient light source may be activated 1,000 times to construct the histogram (232a) and (232b). To construct each histogram a count number for each bin is recorded in the detector and for each histogram there may be 50 to 100 bins.

Once the histograms, such as (232a) and (232b) an average travel time, such as average travel times (234a) and (234b), may be determined by finding the peak or maximum value of each histogram, where the determined average travel time may be the central travel time of the time bin with the largest count. One the average travel times for two detectors have been determined, the average travel time difference between the two average travel times may be determined by subtraction. The data throughput of conventional TDCs under practical LiDAR regimes may reach 1 Mbps per detector (“pixel”), or more, corresponding to thousands of Gbps for a mega-pixel array. Moreover, TDCs are typically relatively large and must be situated close to the pixel for accuracy. This results in a large distance between pixels (SPADs), i.e., a large pixel “pitch”, as well as poor fill factor-usually less than 20% of the surface occupied by a combination of SPAD and memory is occupied by the SPAD.

In contrast, the present method disclosed herein omits the memory-intensive histogram storage requirement. Instead, each FAD unit requires only a single count to be stored between a pair of pixels. This may result in a 100× reduction in data throughput per pixel (compared to computing absolute travel times histograms). In addition to the lower power requirement and readout circuit complexity, this data throughput reduction is key for scalability, makes higher spatio-temporal sampling rates feasible. Together these advantages constitute a clear improvement over conventional TDC base LiDAR systems.

FIG. 2C illustrates the present method. The present method forms pairs of detectors, such as SPADs, each pair linked by first arrival detector (“FAD”) unit. For example, the linked pair of detectors may be spatially adjacent detectors. Denoting the two detectors forming a pair as detector A and detector B, for each activation of the transient light source, such as transient light source (102), the FAD unit determines whether the reflected photon arrives at detector A first or at detector B first. When a photon is determined to arrive first at detector A a cumulative count may be increased by a fixed amount. For example, the cumulative may be increased by +1. However, when a photon is determined to arrive first at detector B the cumulative count may be decreased by a fixed amount. For example, the cumulative count may be changed by −1. Chart (240) illustrates the cumulative count (246), whose value is indicated on the vertical axis (242), as a function of increasing activations (“cycle”) of the transient light source (102), indicated on the horizontal axis (244). It may be observed that although the variation in cumulative count with activations is not monotonic the cumulative count gradually becomes increasingly positive in the example illustrated indicating that averaged over repeated activations of the transient light source (102) photons arrive at detector A earlier than at detector B. This observation is indicative of the element of the target scene reflecting photons to detector A are closer to the sensor (108) than the element reflecting photons to detector B. Furthermore, it will be apparent to one of ordinary skill in the art that the larger the magnitude of the final cumulative count after a fixed number of cycles, such as the magnitude indicated by the point (252) the greater the differential distance from the sensor of the points reflecting photons to detector A and B respectively. Herein, the final cumulative count may be denoted “FAD”.

FAD units have a unique, well-behaved, one-to-one mapping between the measured counter value and the differential distance (depth) between the two pixels. As the depth difference is encoded in an intensity-like unit (i.e., the final cumulative count, FAD), this allows one to achieve distance resolution comparable (or some-times better) than conventional LiDAR.

Chart (250) quantifies this relationship between the final value of the cumulative count (252) and the differential distance between reflection points, indicated on the horizontal axis (254), using the curve (256). The curve (256), referred to herein as a “final cumulative count to depth differential relationship”, relates a value of final cumulative count, FAD, (252) obtained after a given number of cycles, such as the value (252a), to a differential distance (254a). Embodiments, such as the methods illustrated in FIG. 2C that only a single number (the cumulative count) need to be stored for each pair of detectors, thus greatly reducing the memory storage requirement of the sensor.

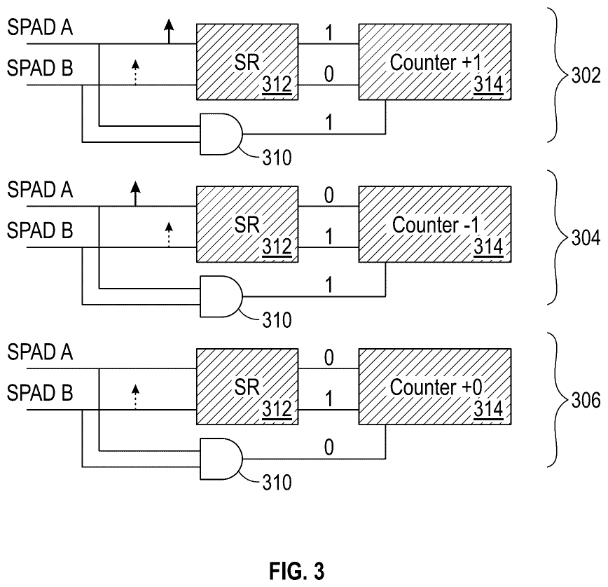

The description provided in the previous two paragraph assumes that a photon arrives at both detector A and detector B and that a determination may be made as to which detector received a photon first. However, other cases may occur, especially in cases of low illumination (e.g., where the target scene is far from the transient light source). In these cases, a photon may not be detected at either of detector A and detector B, or may be detected at only one of detector A or detector B. In these later cases it is desirable for the cumulative count to neither increase nor decrease. FIG. 3 illustrates these cases for SPAD type detectors. In case (302) a photon arrives at SAPD A followed by a photon SPAD B, the logical AND gate (310) outputs a value of 1 and the counter is incremented by a value of +1 using the output of the set-reset switch (312). In case (304) a photon arrives at SAPD B followed by a photon SPAD A, the logical AND gate (310) outputs a value of 1 and the counter is decremented by a value of +1 (or, equivalently, incremented by a value of −1). However, in case (306) a photon is detected by SPAD B but no photon is detected by SPAD A, the logical AND gate outputs a value of 0 and the counter value is unchanged. One of ordinary skill in the art will understand how the illustrated circuits illustrated in FIG. 3 will respond if a photon is received only by SPAD A but not SPAD B, and if neither SPAD A nor SPAD B detect a photon.

FIGS. 4A-4B relate to the above-mentioned exemplary design featuring 16 pixels. The exemplary design was fabricated on a 0.18 μm CMOS and tested as described below. It will be understood that the exemplary design is not limiting. For example, the number of pixels and dimensions of the design may be suitably varied.

The reduced memory requirement resulting from no longer needing to accumulate a histogram allows the spatial footprint of the FAD-based detectors to be significantly smaller as illustrated in FIGS. 4A-4C. As shown in FIG. 4A a SPAD (402) may typically be 30 microns in diameter, a typical TDC circuit (404) may occupy a square with dimensions of 60×60 microns, and the memory required to store the histogram (408) may occupy a square with dimensions of 200×200 microns. In contrast, the FAD circuitry (406) may occupy a square with dimensions of only 20×20 microns, and the circuitry required for the counter (408) may occupy a square with dimensions of only 40×40 microns.

As a result of the smaller spatial size of the FAD and counter design in comparison to the traditional TDC architecture, the photon detectors, e.g., SPADs, may be positioned more closely together in the FAD design then in conventional TDC designs. This is illustrated in FIGS. 4B and 4C. FIG. 4B shows two TDC pixels (422a, 422b) each comprising a photon detector (SPAD) (426) and the associated memory storage (424). The resulting center-to-center distance between the photon detectors is indicated by the arrow (428). In comparison, the two photon detectors in the FAD LiDAR design disclosed herein is shown in FIG. 4C. Only the FAD (430) separates the two photon detectors (426) giving a center-to-center separation indicated by the arrow (432) that is significantly smaller than that for the conventional TDC design.

FIG. 4D shows a micrograph of a chip embodying the disclosed design while FIG. 4E provides dimensions of the elements of the chip and indicates the disposition of the circuitry elements.

A FAD may consist of a single Set/Reset Latch (SR latch) to identify the pixel with first photon arrival, a single up-down counter, and an AND logic gate. Design layouts may occupy a 10× reduction in area compared to traditional histogram generation circuitry. The chip encapsulates an array of 4 SPADs and counting circuitry placed outside of the array. Care should be taken to ensure that the readout nets from each pixel are closely matched in path length. The design achieves a fill-factor of 36% with little additional design effort.

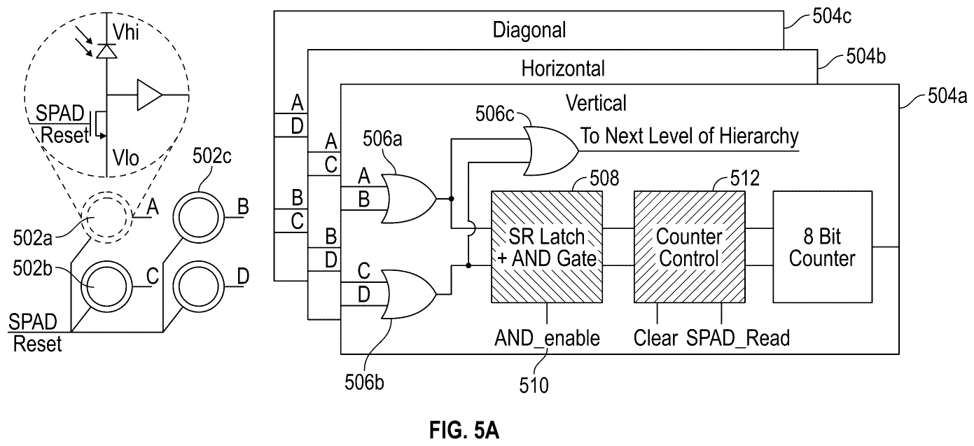

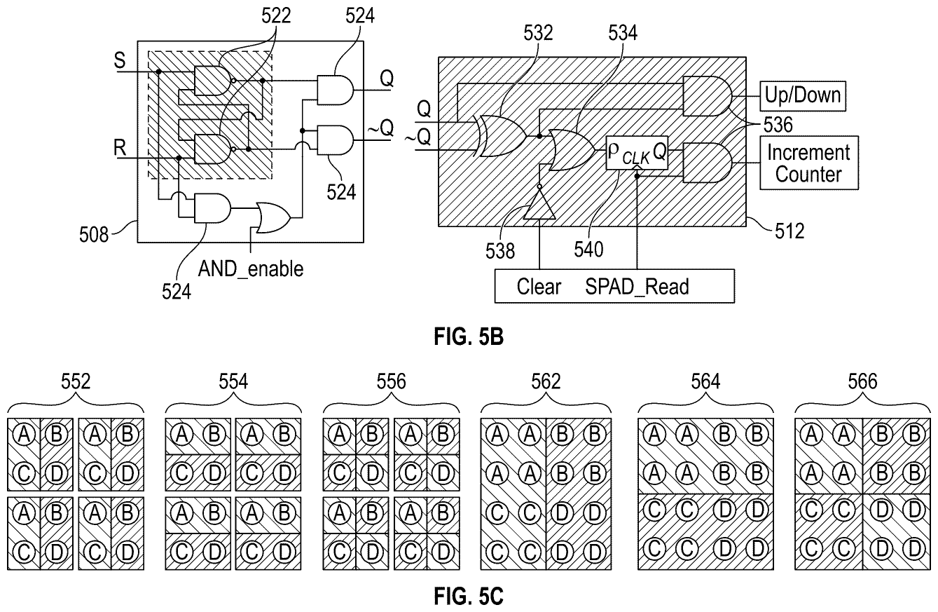

FIG. 5A depicts an example layout of four SPADs (502a-d) arranged in a square configuration. FAD units may be disposed between them in such a manner as to connect the SPADs horizontally, i.e., to connect SPAD (502a) to SPAD (502b), and SPAD (502c) to SPAD (502d), and/or to connect the SPADs vertically, i.e., to connect SPAD (502a) to SPAD (502c), and SPAD (502d) to SPAD (502d), and/or to connect the SPADs diagonally, i.e., to connect SPAD (502a) to SPAD (502d), and SPAD (502b) to SPAD (502c). The internal design of the FAD units connecting the SPADs are illustrated for the vertically connecting FAD (504a), while the internal design of the horizontally and diagonally connecting SPADs (504b) and (504c) are not shown but may be identical or similar to vertically connected SPAD (504a). For example, the output of each SPAD may be connected to three FADs, which determine horizontal, vertical, and diagonal differences by permuting the ordering of the SPAD inputs.

The binary output of a SPAD lends itself naturally to a Haar compression scheme, where pixel outputs are summed in horizontal, vertical, and diagonal groups, and differences between these groups are recorded. Differencing in this context can be performed using a NAND-type SR latch, while summation can be performed using OR gates between SPAD outputs. The on-chip digital circuitry to compute this summation and difference are depicted in FAD (504a). The output of SPAD (502a) and SPAD (502b) are received by logical OR gate (506a), while the output of SPAD (502c) and SPAD (502d) are received by logical OR gate (506b), and the output of these two OR gates are transmitted to the input of a SR latch and logical AND gate circuit (508). An AND gate (510) may also be connected between to the outputs of the SPADs, which can be optionally enabled. When enabled, only time-windows where both groups of SPADs saw at least one photon event will cause the counter to increment. (In FIG. 5B this is shown in parallel with the SR latch). In turn the output of the SR latch and logical AND gate circuit (508) are input into counter control (512) that performs the cumulative count described previously. The counter control (512) may be read and cleared periodically under the control of a first clock, referred to herein as a “SPAD clock”, after the activation of the transitory light source a predetermined number of times.

The output of logical OR gates (506a) and (506b) may further be combined using an additional logical OR gates (506c) with the output passed to a higher hierarchical level of FAD units that may be used to determine differences between larger groups of SPADs. This process will be discussed further in reference to FIG. 5C below. However, the structure of these higher-hierarchical-level FAD units may be similar or identical to the FAD unit (504a).

The low-level binary operations are performed every SPAD cycle, controlled by a second clock (not shown) termed a “fast clock”. When the first photon event during a window occurs, that SPAD's group sends a high signal to the SR latch, which locks in the first arrival until it is reset by the SPAD Reset signal. The output of the SR latch is connected to a counter control unit that controls an up/down counter, such as an 8-bit counter. The counter counts down if the first group of SPADs (e.g., AB in the horizontal case) receives a photon first; it counts up if the second group responds first, and it does not count up or down if neither group responds (e.g., under low flux). The SPADs are reset synchronously at the start of every window by the SPAD Reset signal. To ensure that the SPAD Read and SPAD Reset signals remain synchronized, these are generated on-chip as discussed below.

FIG. 5B depicts an example of the internal structure of the SR latch and logical AND gate (508) and the control counter (512). The SR latch and logical AND gate (508) may include two logical NAND gates (522), three logical AND gates (524), and an AND enabled logical OR gate (510), configured as shown in FIG. 5B to received two signals, “S” and “R” from the output of logical OR gates (504a) and (504b) and output two signals, “Q” and “˜Q”.

Similarly, control counter (512) may contain a logical XOR gate (532) a logical OR gate (534) and two logical AND gate (536) configured as shown in FIG. 5B. In addition, n control counter (512) may contain a logical NOT gate (538) under control of the fast clock and an element (540) to read the SPAD.

As mentioned previously, groups of SPADs may be arranged in a hierarchical manner as illustrated in FIG. 5C. FIG. 5C shows an array of 16 SPADs. Charts (552), (554), and (556) show the SPADs connected at the lowest level of hierarchy with FAD differencing applied vertically, chart (552), horizontally, chart (554), and diagonally, chart (556). At the next level of hierarchy, the output of each subgroup of SPADs are summed and the FAD differencing is applied to the groups with FAD differencing applied vertically, chart (562), horizontally, chart (564), and diagonally, chart (566).

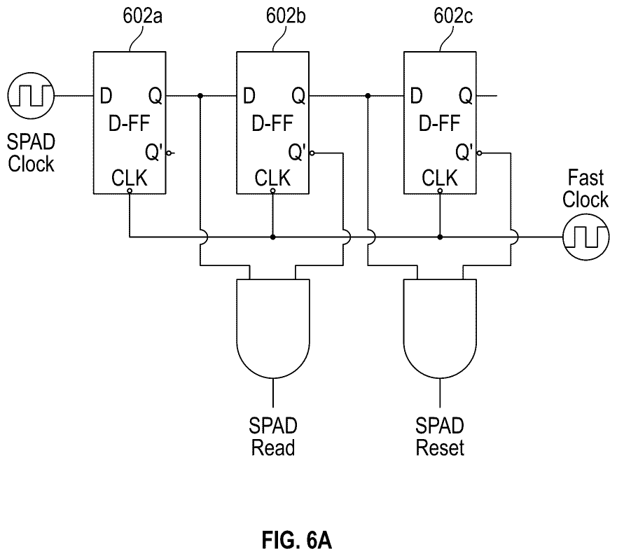

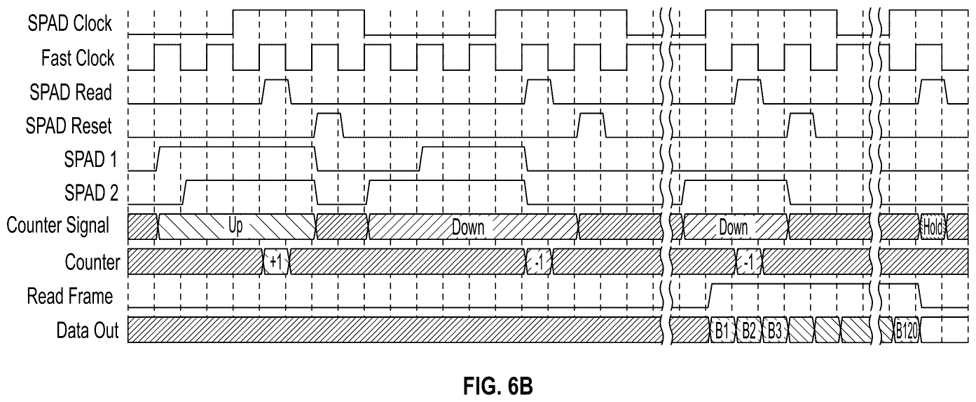

The SPADs may be reset synchronously at the start of every window by the SPAD Reset signal. To ensure that the SPAD Read and SPAD Reset signals remain synchronized, these were generated on-chip as shown in FIG. 6A using three D flip-flops (602a-c) and two clocks: a slower clock which provides the time-window for the SPADs, and a faster clock that is at least 5× the frequency of the slower clock. The user determines the number of read/reset SPAD cycles per frame. One frame may consists of the readout from each of 15 8-bit counters (horizontal, vertical, and diagonal components for four 2×2 sub-blocks and one 4×4 global block), as described in the previous paragraph, and is read serially from a shift register. The array may begin collecting the next frame while the previous frame is being read, as in FIG. 6B. Finally, the outputs of every SPAD in the array are connected via OR gates to a separate top-level readout, which gives a summation of all cycles during which any photon event occurred.

In accordance with one or more embodiments, the depth difference determination abilities of FAD units can be used to perform 3D imaging from date recorded by 2D detector arrays connected pair-wise by FAD units. First, every pair of neighboring detectors, such as SPADs, both horizontally and vertically, are connected by FAD units to acquire independent orthogonal depth differential information. Second, illumination intensity information may be captured and used to determine per-pixel reflectivity and background information. In some embodiments, this may be achieved with either an additional counter per pixel, while in other embodiments linear mode pixels (which tend to be 100× smaller in area) may be incorporated next to at least some SPAD pixels. Third, in some embodiments, to provide robustness of operation and the ability to handle large depth discontinuities, sparsely distributed pixels with individual TDCs. Typically, only one such pixel TDC pixel may be needed for every 10×10 array of FAD pixels. This may be achieved by using the box clique structure or tiling.

Embodiments may allow a background signal (\hat{β}) and reflectivity estimates (α₁, α₂) to be obtained. For example, when background correction is needed, background estimates can be obtained by capturing intensity measurements in the absence of activating transient light sources. Pulse intensities may then be estimated by subtracting the background from each count, α₁, α₂, from the signal recorded when the transient light source is activated. In some embodiments, for 2D measurements, a denoising step may be further applied to refine the intensity estimations.

In accordance with some embodiments, Edges of objects within the target scene may be detected by thresholding the final values of the differential count. When background is low, it may be assumed that photons arriving at both photon detectors originate at the transient light source. In this situation the expected value of the final cumulative count, FAD, may be given by:

$$E [ F A D ] = - {N}_{cycles} {α}_{1} {α}_{2} erf ( \frac{Δτ}{2 σ} ) \qquad Eqn ( 1 )$$

where Δτ denoted the arrival time difference, and σ is a standard deviation incorporating the width of the transitory light source pulse and temporal jitter of the SPAD, and FAD denotes the final value of the differential count. To decouple FAD counts with intensity and exposure, a normalized FAD count may be introduced:

$$n F A D = \frac{F A D}{{N}_{cycles} {α}_{1} {α}_{2}} \qquad Eqn ( 2 )$$

The final cumulative count, FAD, to depth differential relationship, chart (250) of FIG. 2C), shows that the FAD counts saturate whenever the depth differences are too high. In common scenes, high depth differences occur at depth edges. Thus, in some embodiments, nFAD saturation may be used as an indicator for pixels proximal to object edges. Thus, the absolute value nFAD counts may be thresholded. In some instances, depth edges close to hard intensity shadows may lead to spurious depth edges being detected. This can be alleviated, when we have 2D nFAD measurements, by applying common edge detection schemes, e.g., a Canny edge detector.

For two adjacent points on a continuous surface moment-matching may be performed to determine a coarse estimation of the depth differentials, [symbol] =−2σ inverf (nFAD), where inverf denotes the inverse error response function.

In one or more embodiments the depth differential may be equal to the “depth gradient”, while in other embodiments the depth differential may include a scaling factor. For example, the depth gradient may be defined as equal to the depth difference divided by a spatial separation of the pixels. In still other embodiments, the depth gradient may refer to a vector quantity with components equal to the depth differential in each of two orthogonal directions.

Given depth differentials in both the x and y directions, an initial estimate of per-pixel surface normal maps may be obtained. The normal vector, n, at each pixel may be determined as:

$${n}_{u} = {[ {\partial }_{x} z , {\partial }_{y} z , - 1 ]}^{T} , n = \frac{{n}_{u}}{‖ {n}_{u} ‖} \qquad Eqn ( 3 )$$

where ∂ₓz and ∂_{y}z correspond to partial derivative of depth in the x and y directions, respectively. ∂ₓz and ∂_{y}z may be estimated by normalizing [symbol] by dividing [symbol] by the product of pixel pitch and lens magnification factor. Note, [symbol] corresponds to the path difference between pixel and not strictly depth differential. This may become significant for embodiments with a large field of view. For such embodiments, a simple perspective projection may be applied. Such simple perspective projections are well known in the field.

When background intensity is high and the scene contains large albedo variation, correction for the resulting bias caused by background may be necessary before computing the final cumulative count value, FAD. In this situation the bias may depend not simply on the differential travel time but on the absolute value of the travel time. In some embodiments, the absolute value of travel time, τ̅, may be determined by integrating a sparse network of TDC detector into the array of photon detectors. In this situation, the edge detection criterion may be written:

$$F A D > B ( {α}_{1} - {α}_{2} ) ( 1 - \frac{2 \overline{τ}}{T} ) + {ω}_{1} B ( {α}_{1} + {α}_{2} ) + {ω}_{2} {α}_{1} {α}_{2} \qquad Eqn ( 4 )$$

where ω₁ and ω₂ are two weights and T denotes the cycle time. Similarly, corrected nFAD values for a smooth surface become:

$$n F A {D}_{corrected} > \frac{F A D / {N}_{cycles}}{{α}_{1} {α}_{2}} - ( {α}_{1} - {α}_{2} ) ( 1 - \frac{2 \overline{τ}}{T} ) \qquad Eqn ( 5 )$$

While the local nFAD measurements enable us to infer local surface normals and depth edges at a high resolution, using straightforward spatial derivatives, these counts are agnostic to the absolute depth of the objects. For estimating the absolute depth, we need to also rely on sparse pixels with TDCs that capture absolute depth at sparse locations. Using this, we can recover a high-resolution depth map of the scene. An overview of an example reconstruction algorithm follows.

If the scene does not contain depth discontinuities, the surface may be reconstructed, up to an undefined depth offset, by integrating the map of determined normals. But for realistic target scenes involving depth discontinuities, such direct integrating of the normal map would fail at the sharp edge discontinuities. Embodiments may also provide an object segmentation map by detecting these discontinuities and this segmentation map to create masked normal maps for each object that may be integrated separately these. For example, in some embodiments the FFT-based Poisson normal integration by Frankot and Chellappa “A method for enforcing integrability in shape from shading algorithms,” IEEE Transactions on pattern analysis and machine intelligence, vol. 10, no. 4, pp. 439-451, 1988, may be used. Such a method may achieve a decent balance between speed and robustness and requires no parameter tuning. Embodiments, such as those described above, may results in depth maps of the objects up to a constant offset. We then use least squares to fit this depth offset per object to combine the per object depth values with depths obtained from the sparse TDCs.

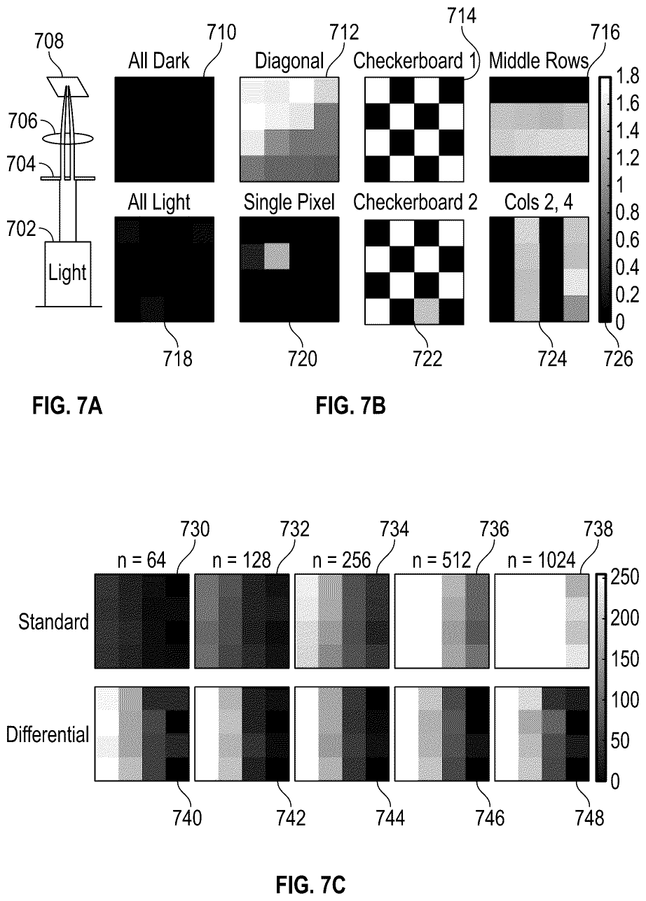

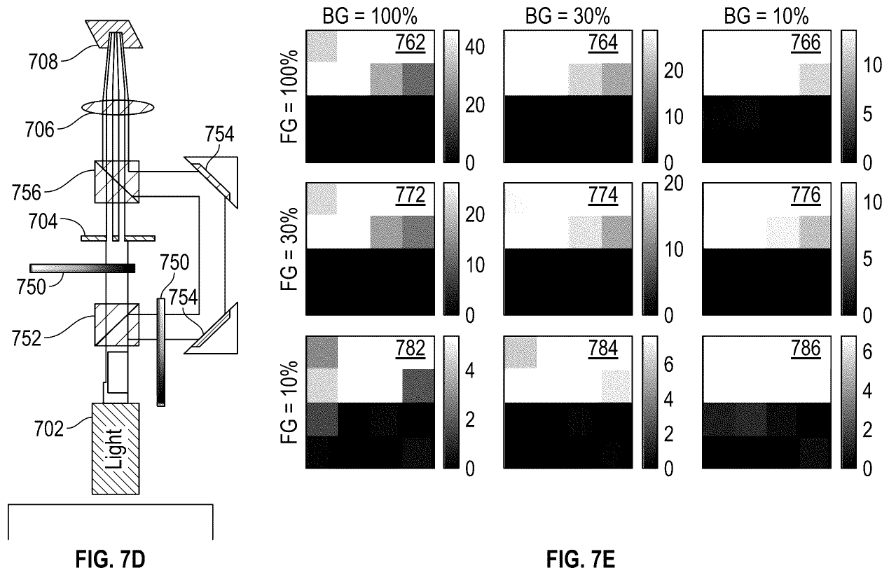

To confirm the FAD-based SPAD array's transitory light is projected onto the array using the experimental apparatus depicted in FIG. 7A. The apparatus comprises a transitory light source (702), specifically a laser, a mask (704), specifically a custom nanofabricated mask, a lens (706) and the FAD-based SPAD array (708). Light from the transitory light source (702) is projected through a custom nanofabricated mask with binary patterns, allowing high-precision control of the light to which the FAD-based SPAD array (708) is exposed. The results for a selection of custom nanofabricated mask are illustrated in FIG. 7B, in charts (710), (712), (714), (716), (718), (720), (722), and (724). In each case the intensity of each pixel is indicated on the grayscale (726). As expected, average (background) levels of light are suppressed, such that different levels of uniform illumination are nearly indistinguishable, while contrast information such as points, stripes, and edges are maintained. For example, uniformly dark mask yields result shown in chart (710) very similar to the result (718) for uniformly light mask.

To compare the performance of the FAD-based SPAD array (708) to a convention array of SPADs operating in TDC mode with 8-bit counters, a gradient pattern mask may be used and 10,000 frames, each with only one photon event per frame. This process gives both the Haar coefficient information and the location of the first arrival for each time-window, allowing two types of images to be constructed: one that accumulates photons wherever there is a first arrival for that frame, emulating a conventional SPAD with counter, and one which records the differential Haar information for n cycles. The results are shown in FIG. 7C. The results for the conventional counter are displayed on the upper row in charts (730), (732), (734), (736) and (738), for increasing values of n, while the results for the FAD-based SPAD array are displayed on the lower row in charts (740), (742), (744), (746) and (748). Note, all the charts in FIG. 7C are displayed on the same color scale. The upper row of charts in FIG. 7C, from the convention array of SPADs operating in TDC mode, clearly show increasing signs of saturation for increasing values of n, leading to a progressive lack of sensitivity. In contrast, the lower row of charts, from the FAD-based SPAD array are consistently superior at preserving the gradient of the mask, even for the highest n values.

FIG. 7D depicts an experimental apparatus designed to investigate the response of the FAD-based SPAD array (708) to varying levels of contrast and background light. In FIG. 7D a beam of transitory light is split into two beams, using a half-silvered reflector (752), each of which passes through a tunable neutral density filter (750). The “foreground” path also passes through a custom mask (704) which illuminates the top half of the chip while covering the bottom half. The second beam, whose direction is manipulated using the corner reflectors (754) provides background intensity, which is directed into the FAD-based SPADs using a second half-silvered mirror (756) in such a manner as to provide uniform illumination across both the upper and lower portion of the FAD-based SPADs. The relative intensity of the foreground and background intensity may be controlled using the neutral density filters (750). The results are shown in FIG. 7E, with each chart (762), (764), (766), (772), (774), (776), (782), (784), and (786) showing the result for a different combination of background (“BG”) and foreground (“FG”) illumination. In all cases shown here, the flux estimate is ≥1 photon/cycle, which would normally cause saturation of a conventional SPAD operating in TDC mode. However, the FAD-based SPAD array preserves the image information under extreme background lighting conditions of 3× and even 10× background to foreground intensity ratios. At higher flux, some effects of local bias between pixels become more apparent, but the structure of the foreground image remains clear.

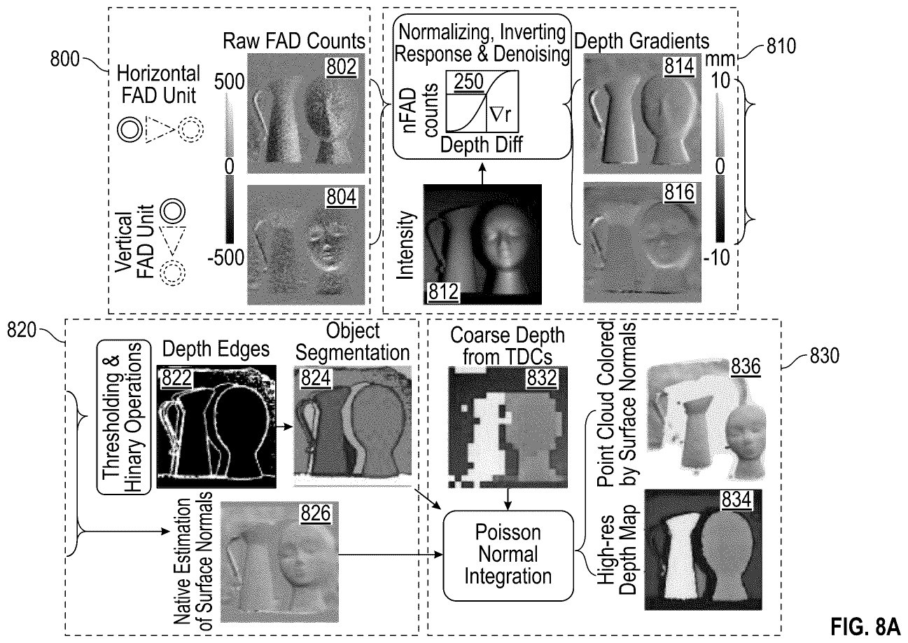

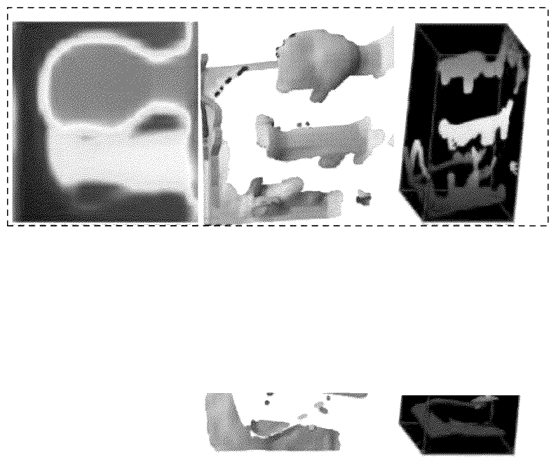

FIG. 8A illustrates a processing flow to generate 3D images from values of the final cumulative differential count (“raw FAD count”), for the target scene (100), in accordance with one or more embodiments. In chart (800) raw FAD counts may be obtained for both photon detectors connected by vertically oriented FAD units and photon detectors connected by horizontally oriented FAD units, producing the raw images (802) and (804), respectively.

Images (804) and (806) may be passed to step (810) where they may undergo normalizing and denoising steps well known in the art before conversion to depth differentials, using the final cumulative count, FAD, to depth differential relationship as shown in chart (250). Further, illumination intensity (802) may be determined from the photon detector recordings may be used to refine the conversion to depth differential, as disclosed previously. A horizontal depth differential image (814) and a vertical depth differential image (816) may result.

A horizontal depth differential image (814) and a vertical depth differential image (816) may be passed to step (820) where thresholding may be performed to obtain edges of objects (822) within the target scene based on discontinuities in either depth differentials or in integrated depth values. Gaps in the object contours may be filled by performing standard morphological operations on the binary contour map. Each resulting fully connected element (enclosed by a boundary) may be treated as a segmented object (824). Further, in step (820) an approximate determination of an image of the surface normal (826) may be determined. The determination may be performed using the spatial derivative of the depth values for each pixels, or the depth differential values for each pixel.

Finally, in step (830) the object segmentation map (824) and the approximate determination of the surface normal (826) may undergo Poisson normal integration and be combined with absolute depth estimates from a coarse array of TDCs (832) to produced high-resolution maps of the depth of objects within the target scene (834) and of surface normal (836).

FIG. 8B shows a simulated comparison of the target scene (840) with the estimated target scene determined using a disclosed embodiment (850) and the estimated target scene determined using a conventional TDC-based approach (860). Each column of results shows the depth map at the top, the surface normal map in the center and a 3D point cloud at the bottom. It will be apparent to one of ordinary skill in the art that the results obtained using the disclosed embodiment (850) are vastly superior to those obtained using a conventional TDC-based approach (880).

It is well known that the performance of conventional LiDAR systems may be influenced by the operating environment, and it is to be expected that the same is true for the disclosed embodiments. In particular, two parameters may be important. First, effective signal to background ratio (“SBR”) is usually defined as the ratio between total received pulse photons and signal photons for a single pixel. For FAD-based systems, because a pair of pixels is involved, it is appropriate to define the SBR as the geometric mean of the individual SBRs of each pixel. Secondly, reflectivity or albedo ration may be defined as α₁/α₂ and quantifies the amount of reflectivity variation between pairs of pixels.

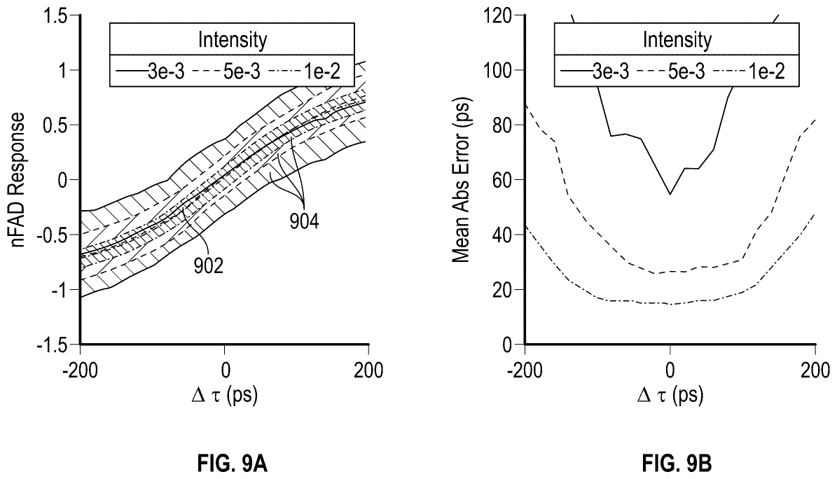

The intensity of the transient light source (“pulse power”) is clearly a factor determining SBR. FIG. 9A shows the normalized FAD response and the mean absolute error if the determined differential time as for three intensity levels: 3e⁻³, 5e⁻³, and 10e⁻³ photon/cycle. To determine these results a dark count rate (the counter internal noise level) of 1000 cps has been assumed and no additional ambient light present has been assumed to be present. Further, both detectors are assumed to have the same power (photon rate) and the travel time difference ranges from −200 ps to +200 ps with a step size of 20 ps. In FIG. 9A, the mean values of the nFAD responses, shown with solid lines (902) match for all three cases. The shaded regions (904) indicate standard deviation. FIG. 9B shows the mean absolute depth estimation errors for the three intensity levels, each obtained from the corresponding standard deviations (904) increase as pulse power decreases. For lower the pulse power, the noise in nFAD increases significantly, since there are fewer dual arrivals forming the signal. Note, the errors also increase as Δτ approaches the saturation points, since the nFAD response starts to flatten and the depth estimation uncertainty increases.

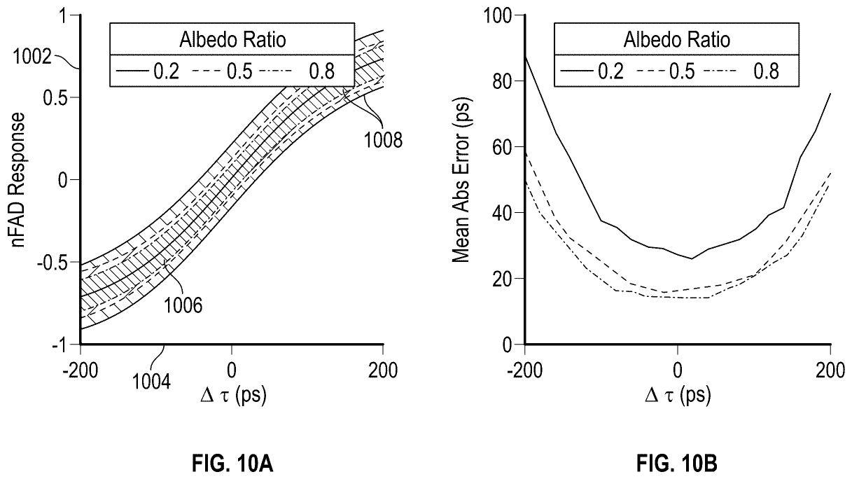

Turning to FIGS. 10A-B, FIG. 10A show the effect of albedo variation for a fixed pulse intensity of the first photon detector of 0.01 and albedo ratios of 0.3, 0.5, and 0.8. FIG. 10A shows the nFAD response on the vertical axis (1002) with the travel time difference indicated on the horizontal axis (1004). The mean values of the nFAD responses, shown with solid lines (1006) match for all three cases, but the standard deviation, shown as shaded regions (1008) increase with decreasing albedo ratio. In FIG. 10B, the mean absolute error of the travel time difference is shown for the three albedo ratios: 0.3, 0.5, and 0.8. It may be observed that as albedo ratio increases, the variance in nFAD and the travel time (or equivalently depth inversion) error both increases, due to fewer dual arrivals. However, the albedo variation causes no bias due to low background.

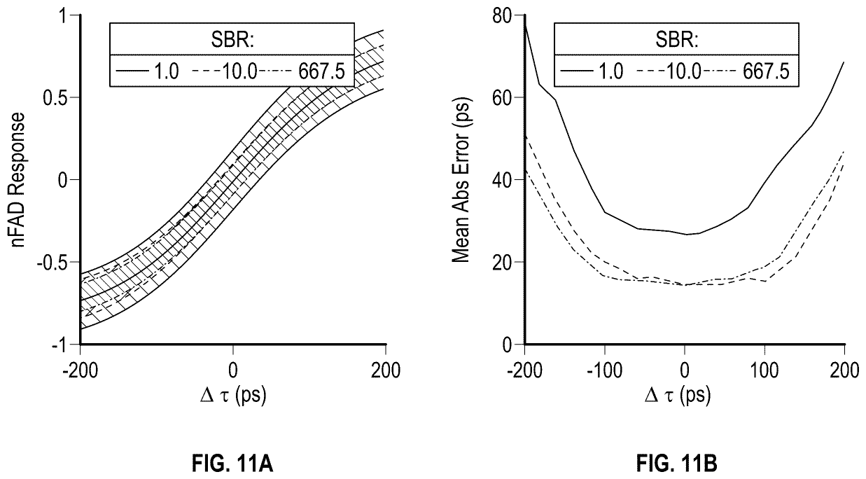

Turning to FIGS. 11A and 11B, FIG. 11A shows the effect of background brightness in the absence of significant albedo variation. The data displayed in FIG. 11A assume there is no albedo variation, specifically each detector receives 0.01 photons/cycle, and SBR values of 1.0, 10., and 667.5. It can be seen, there is little distortion of the expected nFAD curve, except that as SBR increases (i.e., the background intensity lowers), there is less variance. Per-pixel estimation works up to an SBR of around 1, although if SBR decreases further the errors become significant. FIG. 11B shows the mean absolute error for the three SBR values. Although the error is noticeably worse for SBR=1, there is no bias or systematic error.

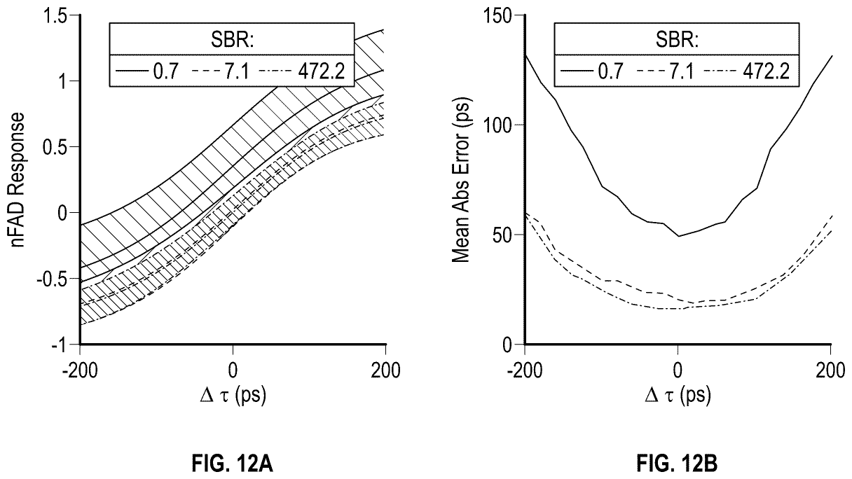

In FIGS. 12A and 12B the effect of background intensity in the presence of high albedo variation. Specifically, in this case the albedo ratio=0.5 and the results for SBR values of 0.7, 7.1, and 472.2 are shown. In this case, as background increases, the uncorrected nFAD are clearly biased as background increases, see FIG. 12A. However, FIG. 12B shows the mean absolute errors in travel time after the application of the bias correction show in Eqn (5). While the resulting corrected errors show a degradation for low SBR, specifically for SBR=0.7, the corrected errors do not exhibit a bias.

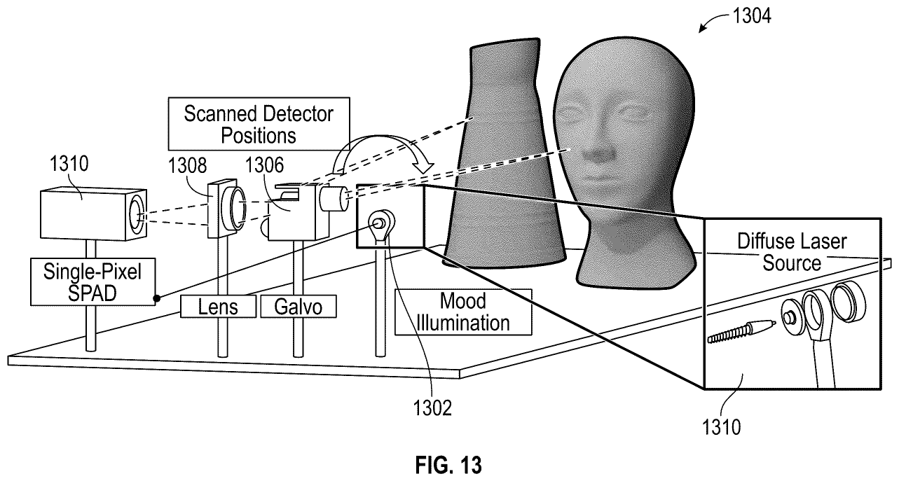

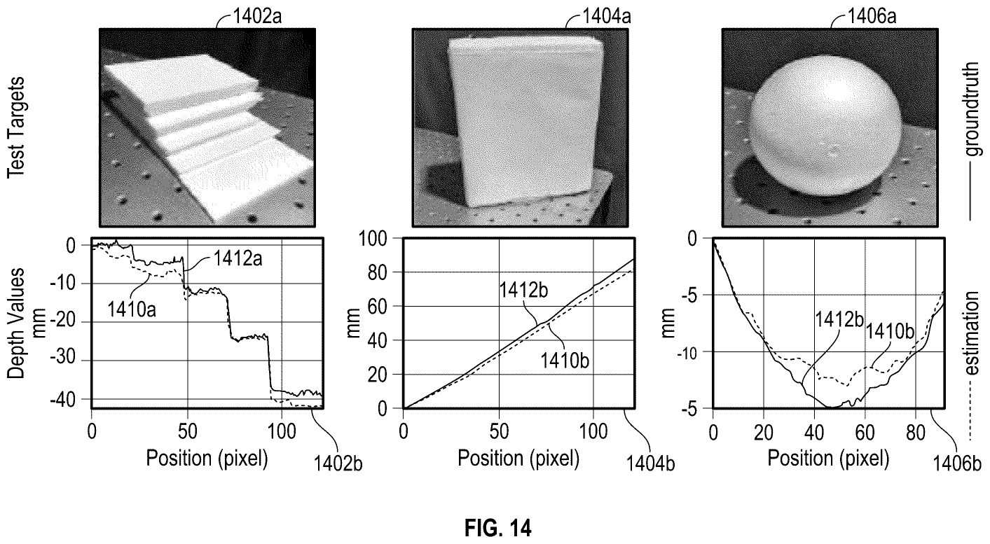

FIG. 13 shows an experimental prototype of the digital image detection apparatus together with a target scene, while FIGS. 14-16 show results from the apparatus. FIG. 13 shows a transient light source (1302), specifically a diffuse laser source, illuminating a target scene (1304). Reflected photons impinge on a galvo controlled mirror (1306) configured to direct the reflected photons through a lens (1308) and into the array of photon detectors (1310). In this case the transient light source (1302) includes a diffuse light source created by passing a laser beam, via an optical fiber, through a ground glass diffuser (1312).

FIG. 14 illustrates results from three different target scenes (1402a, 1404a, 1406a) shown on the top line. The scenes include a staircase object with increasing depth gaps, a plane tilted 45 degrees away from the optical axis, and a sphere. In each case the determined depth values along a horizontal scan line is presented (1402b, 1404b, 1406b) beneath the corresponding target scene (1402a, 1404a, 1406a). In each case the determined depth values-shown by solid line (1410a, b, c) and compared to the true value shown as a dashed line (1412a, b, c). In each case good correspondence is observed.

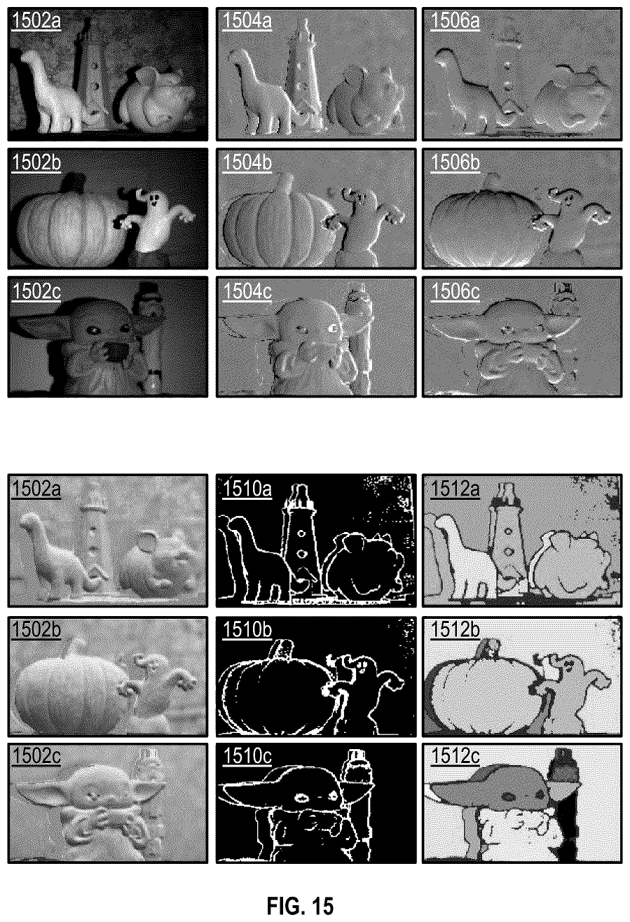

FIG. 15 display results intended to show the performance of embodiments disclosed herein for target scenes showing complex features, specifically multiple objects and variable illumination, such as shadows. The intensity image of three target scenes (1502a-c) are displayed, together with the determined horizontal differential distance (1504a-c) and determined vertical differential distance (1506a-c). The corresponding surface normal images (1508a-c) are displayed together with a determination of the edges of the objects in the target scenes (310a-c) and segmented images (1512a-c). The objects shown in each image are 10-20 cm in scale and span a depth of 0.7 to 1.2 m. 20 cm in scale and span a depth of 0.7-1.2 m. The reconstructed gradients (1504a-c) and (1506a-c) capture fine structures such as the ribs on the pumpkin, nose of the pig and hands of the figurine. Cross-products of the gradients can be used directly to produce high resolution surface normals (1508a-c). Note that the embodied approach can even capture fine wrinkles on the background cloth. The object edges (1510a-c) may be used to produce clean segmentation results (1512a-c). Note, these results have only used relative depth information extracted from nFAD values, i.e., TDCs were used or assumed.

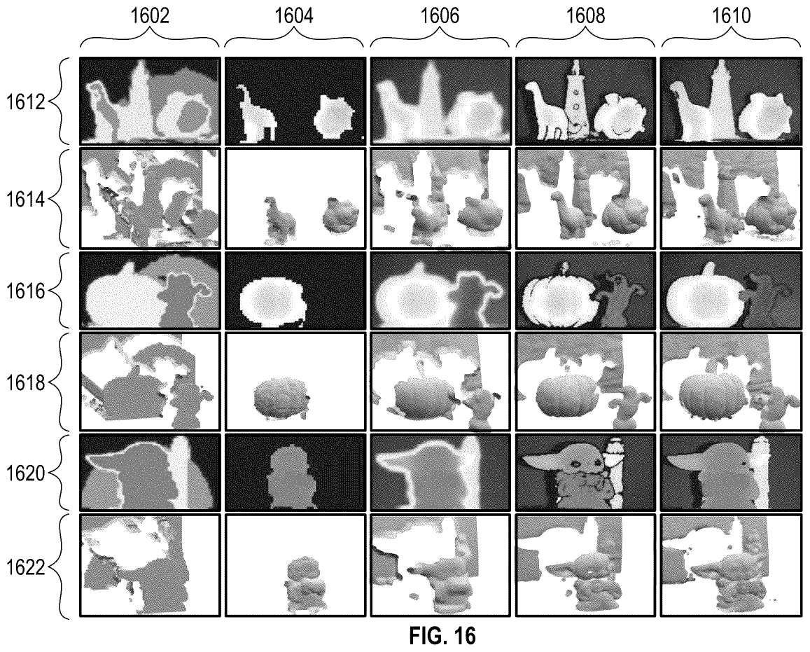

FIG. 16 display a comparison with the results for the three scenes displayed in FIG. 15 obtained using the disclosed embodiment with three conventional flash LiDAR methods and with a ground truth rendering resulting from high-resolution scanning LiDAR. In FIG. 16 columns (1602, 1604, and 1606) show the results from three conventional LiDAR systems, while column (1608) shows the results from an embodiment disclosed herein and column (1610) show the ground truth images. For each column, row (1612) displays the depth map, and row (1614) displays the surface normals for the first target scene, row (1616) displays the depth map, and row (1618) displays the surface normals for the second target scene, and row (1620) displays the depth map, and row (1622) displays the surface normals for the third target scene. It will be clear that the results obtained from an embodiment disclosed herein (1608) are a significant improvement over the results from the three conventional flash LiDAR methods (1602, 1604, 1606) and even over the “ground truth” high-resolution scanning LiDAR, column (1610).

It is informative at this point to consider the performance of the five systems used to produce images shown in FIG. 16. Table 1 summarizes metrics for this performance:

TABLE 1

| | TDC | Bin Width | | |
|---|---|---|---|---|
| | Resolution | (ps) | TDC Range | Net TP (Gb/s) |
| BD10 | 384 × 512 | 1 | 12 | 10,657.0 |
| BD02 | 96 × 128 | 1200 | 12 | 163.3 |
| BD04 | 96 × 128 | 50 | 0.5 | 163.3 |
| BD06 | 48 × 64 | 1 | 12 | 163.3 |
| BD08 | 384 × 512 | 1 | 12 | 163.3 |

The first column of Table 1 indicates the corresponding column of FIG. 16. Table 1 lists the specifications of the full single-pixel scanning and conventional LiDAR baselines, where the net throughput is kept fixed. The specifications are chosen based on state-of-the-art LiDAR works. Coarser spatial resolution is emulated by spatially down-sampling the high resolution depth map from the scanning-based setup shown in FIG. 13. The TDC ranges and bin width are achieved by cropping the range and quantizing the ground truth depths respectively.

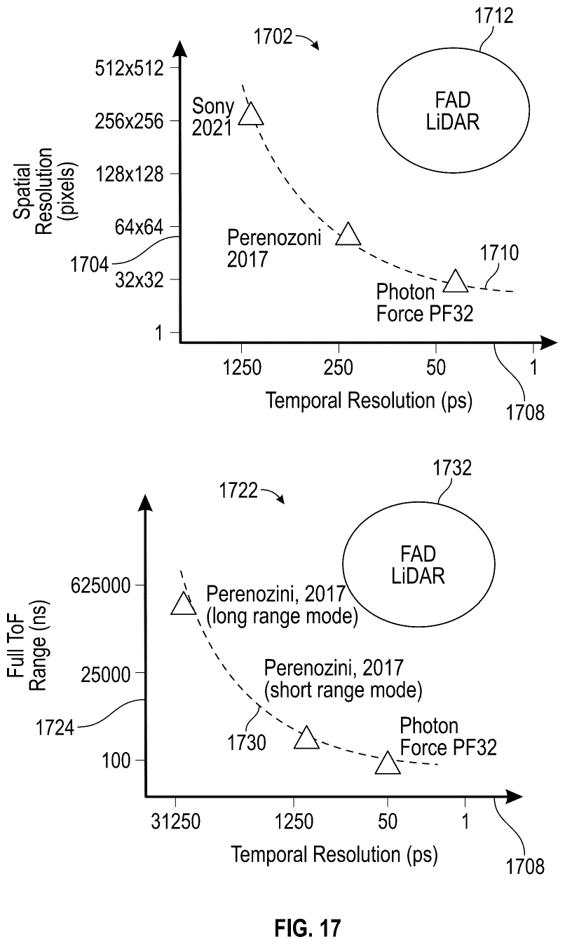

FIG. 17 shows a further comparison of embodiments disclosed herein (“FAD LiDAR”) with conventional LiDAR systems. Chart (1702) indicates the spatial resolution versus temporal (depth) resolution of various conventional LiDAR systems (1710). Spatial resolution is indicated on the vertical axis (1704) and temporal (depth) resolution is indicated on the horizontal axis (1708). The three conventional systems lie on a line (1710) indicating an inverse relationship between spatial resolution and temporal resolution. However, embodiments disclosed herein (1712) may achieve much better spatial resolutions and high temporal resolutions than conventional methods.

Similarly, chart (1722) indicates the full time-of-flight range versus temporal (depth) resolution of various conventional LiDAR systems (1710). Full time-of-flight range is indicated on the vertical axis (1724) and temporal (depth) resolution is indicated on the horizontal axis (1708). The three conventional systems lie on a line (1730) indicating an inverse relationship between full time-of-flight range and temporal resolution. However, embodiments disclosed herein (1732) may achieve much better spatial resolutions and high temporal resolutions than conventional methods.

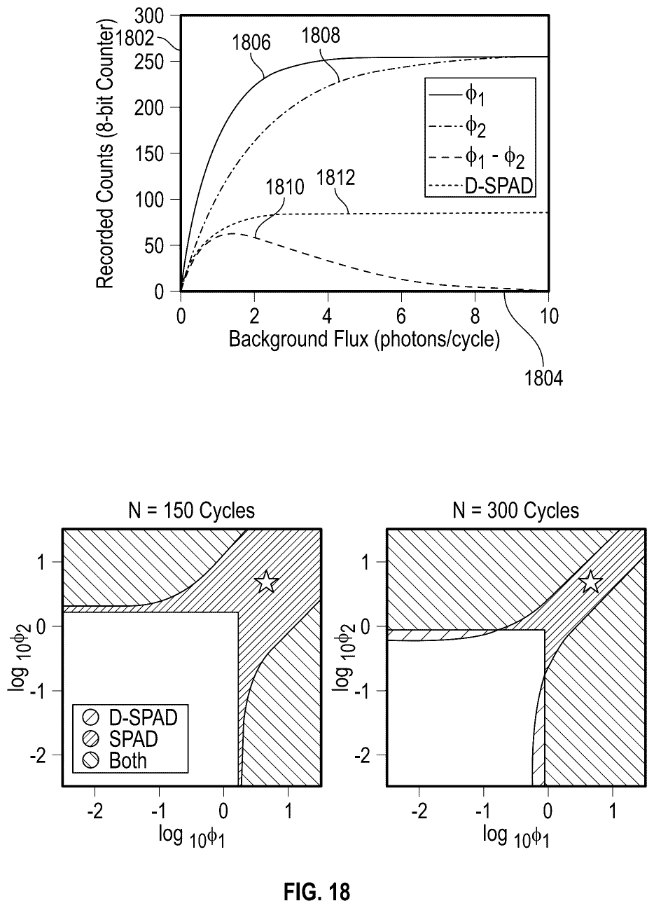

FIGS. 18A and 18B further illustrate advantages of the FAD-based design disclosed herein under conditions of increasing flux. It is well known in the art that spatial information is usually associated more with local gradients in an image than with absolute background levels of light. Thus, a sensor which captures and reports only local differences can therefore reduce the number of bits captured transferred off-chip for further processing with little if any information loss. In the context of SPADs receiving flux, φ, when the flux is low (i.e., each SPAD is unlikely to absorb more than one photon/cycle) such differencing can be accomplished simply by counting photons on two adjacent SPADs and then subtracting, provided the counters have enough bit-depth to avoid saturation. However, at higher flux, two problems can arise: the first is that SPADs will tend to absorb multiple photons per cycle (φT>1), but only report one event. This results in effective saturation, making counts less accurate. Worse, from the perspective of measuring gradients, adjacent pixels with different photon fluxes, φ₁ and φ₂, can both saturate, destroying any difference information. This effect is shown in FIG. 18A. FIG. 18A shows the recorded count from two SPAD detectors operating in TDC fashion, with recorded count indicated in the vertical axis (1802) against background flux level indicated on the horizontal axis (1804). FIG. 18A. shows the results for a first SPAD (1806) and a second SPAD (1808) each operating in TDC fashion. The difference, between the recorded count of the first and second SPADs operating in TDC fashion is shown by the dashed line (1810). It can be seen that at high background flux levels the recorded count from each of the SPADs saturate and their difference declines to a small or zero value. In contrast, the result from the two SPADs operating as a differential counter using the disclosed FAD-based configuration is indicated by the line (1812), indicating the perception of a depth difference is preserved. The flux regimes where the conventional SPADs, operating in TDC fashion, and the disclosed FAD-based SPADs will saturate are shown in FIG. 18B, assuming an 8-bit counter, with values of 0 to 255 for the convention SPAD configuration and for the differential case (where one bit is allocated to the sign) the limits are −127 to +128.

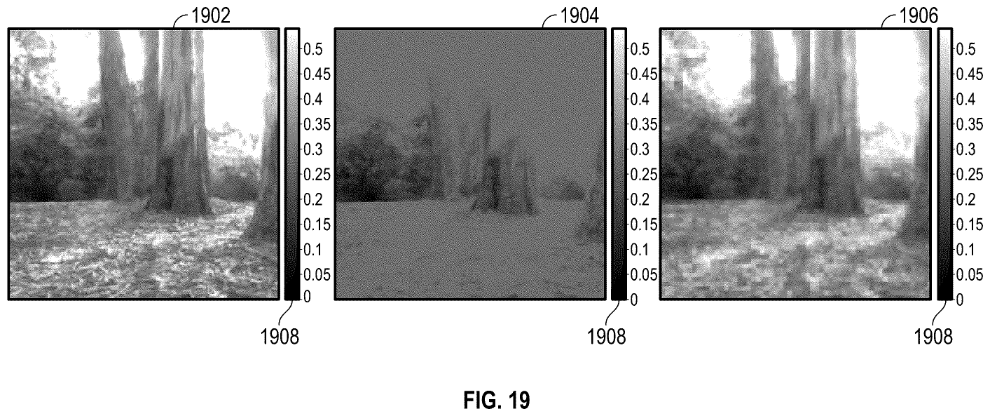

FIG. 19 illustrates the result of the greater robustness under higher flux conditions. Image (1902) depicts the ground truth intensities of a target scene, while image (1904) depicts the results of a convention SPAD design operating in TDC fashion. Much of the detail has been lost in (1904) due to saturation of the detectors (SPADs). In contrast, image (1906) illustrates the results from a disclosed FAD-based SPADs configuration. Note, all the images in FIG. BG are displayed on the same grayscale (1908) The superiority of image (1906) over image (1904) is readily apparent.

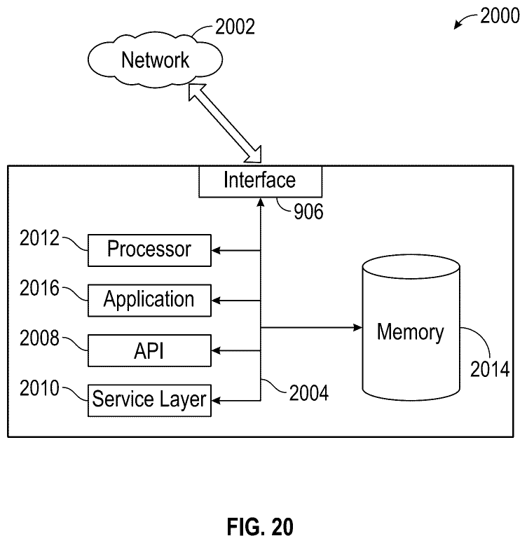

While the steps of detecting the arrival of a photon, the determination of at which of a pair of photon detectors the photon arrived first and the cumulative counting of which photon detector received the photon first may be performed “on-chip”, the conversion of the final value of the cumulative count for each pair of photon into an image of intensity, of depth from the array of detectors, of the orientation of the surfaces of objects in the scene, etc., are operations that may not plausibly be performed mentally or manually. The formation of such images from the final values of the cumulative counts may be performed with the assistance of a suitably configured computer system, either in real time or after the fact (offline). Such a computer system is depicted schematically in FIG. 20.

FIG. 20 is a block diagram of a computer system (2000) used to provide computational functionalities associated with described algorithms, methods, functions, processes, flows, and procedures as described in the instant disclosure, according to an implementation. The illustrated computer system (2000) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system (2000) may include a computer that includes an input device, such as a keypad, keyboard, touch screen, or other device that can accept user information, and an output device that conveys information associated with the operation of the computer system (2000), including digital data, visual, or audio information (or a combination of information), or a GUI.

The computer system (2000) can serve in a role as a client, network component, a server, a database or other persistency, or any other component (or a combination of roles) of a computer system for performing the subject matter described in the instant disclosure. The illustrated computer system (2000) is communicably coupled with a network (2002). In some implementations, one or more components of the computer system (2000) may be configured to operate within environments, including cloud-computing-based, local, global, or other environment (or a combination of environments).

At a high level, the computer system (2000) is an electronic computing device operable to receive, transmit, process, store, or manage data and information associated with the described subject matter. According to some implementations, the computer system (2000) may also include or be communicably coupled with an application server, e-mail server, web server, caching server, streaming data server, business intelligence (BI) server, or other server (or a combination of servers).

The computer system (2000) can receive requests over network (2002) from a client application (for example, executing on another computer system (2000)) and responding to the received requests by processing the said requests in an appropriate software application. In addition, requests may also be sent to the computer system (2000) from internal users (for example, from a command console or by other appropriate access method), external or third-parties, other automated applications, as well as any other appropriate entities, individuals, systems, or computers.

Each of the components of the computer system (2000) can communicate using a system bus (2004). In some implementations, any or all of the components of the computer system (2000), both hardware or software (or a combination of hardware and software), may interface with each other or the interface (2006) (or a combination of both) over the system bus (2004) using an application programming interface (API) (2008) or a service layer (2010) (or a combination of the API (2008) and service layer (2010). The API (2008) may include specifications for routines, data structures, and object classes. The API (2008) may be either computer-language independent or dependent and refer to a complete interface, a single function, or even a set of APIs. The service layer (2010) provides software services to the computer system (2000) or other components (whether or not illustrated) that are communicably coupled to the computer (2000). The functionality of the computer (2000) may be accessible for all service consumers using this service layer. Software services, such as those provided by the service layer (2010), provide reusable, defined business functionalities through a defined interface. For example, the interface may be software written in JAVA, C++, or other suitable language providing data in extensible markup language (XML) format or other suitable format. While illustrated as an integrated component of the computer (2000), alternative implementations may illustrate the API (2008) or the service layer (2010) as stand-alone components in relation to other components of the computer (2000) or other components (whether or not illustrated) that are communicably coupled to the computer (2000). Moreover, any or all parts of the API (2008) or the service layer (2010) may be implemented as child or sub-modules of another software module, enterprise application, or hardware module without departing from the scope of this disclosure.

The computer (2000) includes an interface (2006). Although illustrated as a single interface (2006) in FIG. 20, two or more interfaces (2006) may be used according to particular needs, desires, or particular implementations of the computer (2000). The interface (2006) is used by the computer (2000) for communicating with other systems in a distributed environment that are connected to the network (2002). Generally, the interface (2006) includes logic encoded in software or hardware (or a combination of software and hardware) and operable to communicate with the network (2002). More specifically, the interface (2006) may include software supporting one or more communication protocols associated with communications such that the network (2002) or interface's hardware is operable to communicate physical signals within and outside of the illustrated computer (2000).

The computer (2000) includes at least one computer processor (2012). Although illustrated as a single computer processor (2012) in FIG. 20, two or more processors may be used according to particular needs, desires, or particular implementations of the computer (2000). Generally, the computer processor (2012) executes instructions and manipulates data to perform the operations of the computer (2000) and any algorithms, methods, functions, processes, flows, and procedures as described in the instant disclosure.

The computer (2000) also includes a memory (2014) that holds data for the computer (2000) or other components (or a combination of both) that may be connected to the network (2002). For example, memory (2014) may be a database storing data consistent with this disclosure. Although illustrated as a single memory (2014) in FIG. 20, two or more memories may be used according to particular needs, desires, or particular implementations of the computer (2000) and the described functionality. While memory (2014) is illustrated as an integral component of the computer (2000), in alternative implementations, memory (2014) may be external to the computer (2000).

In addition to holding data, the memory may be a non-transitory medium storing computer readable instruction capable of execution by the computer processor (2012) and having the functionality for carrying out manipulation of the data including mathematical computations.

The application (2016) is an algorithmic software engine providing functionality according to particular needs, desires, or particular implementations of the computer (2000), particularly with respect to functionality described in this disclosure. For example, application (2016) can serve as one or more components, modules, applications, etc. Further, although illustrated as a single application (2016), the application (2016) may be implemented as multiple applications (2016) on the computer (2000). In addition, although illustrated as integral to the computer (2000), in alternative implementations, the application (2016) may be external to the computer (2000).

There may be any number of computers (2000) associated with, or external to, a computer system containing computer (2000), each computer (2000) communicating over network (2002). Further, the term “client,” “user,” and other appropriate terminology may be used interchangeably as appropriate without departing from the scope of this disclosure. Moreover, this disclosure contemplates that many users may use one computer (2000), or that one user may use multiple computers (2000).

In some embodiments, the computer (2000) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

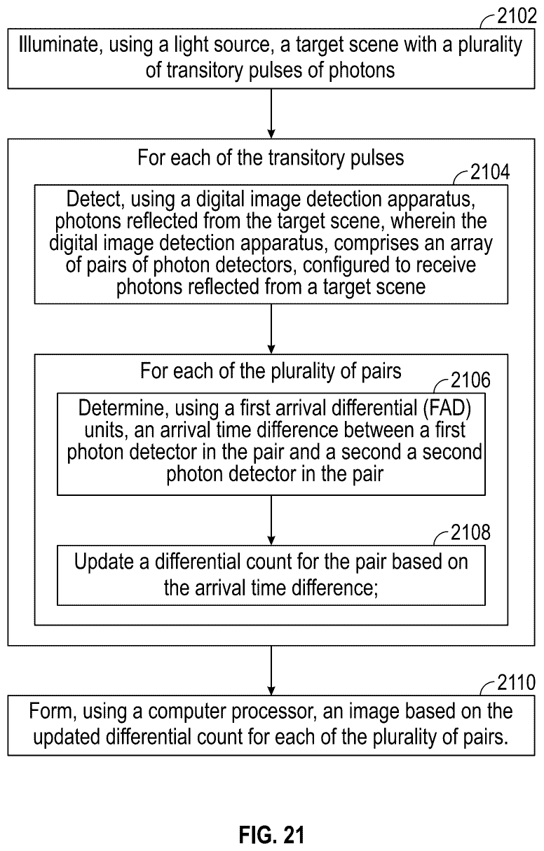

FIG. 21 depicts a flowchart illustrating a workflow for determining an image of a 3D object using a digital image detection apparatus, in accordance with one or more embodiments.

In step (2102) a target scene may be illuminated with a plurality of transitory pulses of photons. The photons may be provided by a pulsed laser. The pulsed laser beam may be transmitted via an optical fiber and/or may be transmitted through a ground glass lens prior to illuminating a target scene. The effect of the ground-glass lens may be to provide a diffuse illumination of the target scene.

For each of the transitory pulses, in step (2104), photons reflected from the target scene may be detected using a digital image detection apparatus. The digital image detection apparatus may include an array of pairs of photon detectors, with each photon detector configured to receive photons reflected from a target scene. The digital image detection apparatus may further include lens to focus the photons on the photon detector. The photon detectors may be single photon avalanche diodes (SPADs). Each photon detector in a pair of photon detectors may be connected to the other photon detector in the pair by a first arrival differential (FAD) unit. A FAD may determine a first arrival differential time in a first direction or in a second direction, where the first direction is orthogonal to the second direction. Further a FAD may determine a first arrival differential time in a third direction where the third direction is intermediate between the first direction and the second direction.

For each of the plurality of pairs, in step (2106), an arrival time difference between a first photon detector in the pair and a second a second photon detector in the pair may be determined, using a first arrival differential (FAD) units.

In step (2108) a differential count for each pair may be updated based on the arrival time difference.

In step (2110) an image based on the updated differential count for each of the plurality of pairs may be formed using a computer processor. The image may be a 3D image that may display the depth, or distance from the detector, of objects in the image. Alternatively, the image may display the spatial orientation of normal to the surfaces of the 3D objects within the image. Or the image may display the locations of the edges of objects present within the image. Alternatively, the image may display segmented estimates of objects within the image. The examples of images provided above are provided as illustrations only and should not be construed as limiting the scope of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A digital image detection apparatus, comprising:
an array of photon detectors, configured to receive photons reflected from a target scene; and
a plurality of first arrival differential (FAD) units, wherein each FAD unit is configured to receive a first input from a first photon detector in the array and a second input from a second photon detector, and wherein, each FAD unit comprises:
a set-reset (“SR”) latch, configured to receive the first input and the second input and to determine which of the first input and the second input arrives earlier in time, and
a counter control unit, configured to receive an output from the SR latch and increment a differential count based on the output.

2. The apparatus of claim 1, wherein each photon detectors of the array of photon detectors comprises a single photon avalanche diode (“SPAD”).

3. The apparatus of claim 1, wherein the array of photon detectors is a two-dimensional array.

4. The apparatus of claim 1, wherein the first photon detector and the second photon detector are spatially adjacent to one another.

5. The apparatus of claim 4, wherein each photon detector in the array of photon detectors is connected by a first FAD to a first neighboring photon detector in a first direction and by a second FAD to second neighboring photon detector in a second direction, wherein the first direction and the second direction are orthogonal to one another.

6. The apparatus of claim 5, wherein each photon detector is further connected by a third FAD to a third neighboring photon detector in a third direction, wherein the third direction is intermediate between the first direction and the second direction.

7. The apparatus of claim 1, wherein each FAD further comprises a logical OR gate configured to combine the output of a plurality of photon detectors prior to inputting the combination to the SR latch.

8. The apparatus of claim 1, further comprising:
a first clock, configured to specify a sample time-window for the array of photon detectors, and
a second clock connected, configured to determine a final value of the differential count.

9. A system, comprising:
a light source, configured to illuminate a target scene with a transitory pulse of photons;
a digital image detection apparatus, comprising:
an array of photon detectors, configured to receive photons reflected from the target scene; and
a plurality of first arrival differential (FAD) units, wherein each FAD unit is configured to receive a first input from a first photon detector in the array and a second input from a second photon detector, and wherein, each FAD unit comprises:
a set-reset (“SR”) latch, configured to receive the first input and the second input and to determine which of the first input and the second input arrives earlier in time,
a counter control unit, configured to receive an output from the SR latch and increment a differential count based on the output; and
a computer processor, configured to form an image based on the output of the counter control unit of the plurality of FAD units.

10. The system of claim 9, wherein the light source comprises a pulsed laser.

11. The system of claim 9, wherein the computer processor is configured to form the image by:
determining a depth differential between each of a plurality of adjacent pixels based, at least in part on a final cumulative count to depth differential relationship.

12. The system of claim 9, wherein the computer processor is configured to form the image by:
determining, for each of a plurality of adjacent pixels, a unit vector normal to a surface of an object in the target scene based, at least in part, on a partial derivative of the depth differentials along two orthogonal directions.

13. The system of claim 9, wherein the digital image detection apparatus further comprises an optical lens, configured to focus photons reflected from a target scene.

14. A method, comprising:
illuminating, using a light source, a target scene with plurality of transitory pulses of photons;
for each of the transitory pulses:
detecting, using a digital image detection apparatus, photons reflected from the target scene, wherein the digital image detection apparatus, comprises an array of pairs of photon detectors, configured to receive photons reflected from a target scene,
for each pair of photon detector in the array of pairs of photon detectors;
determining, using a first arrival differential (FAD) unit, an arrival time difference between a first photon detector in the pair and a second a second photon detector in the pair, and
updating a differential count for the pair based on the arrival time difference; and
forming, using a computer processor, an image based on the updated differential count for each of the plurality of pairs.

15. The method of claim 14, wherein forming the image comprises determining a depth differential between each of a plurality of adjacent pixels based, at least in part on a normalized final cumulative count to depth differential relationship.

16. The method of claim 14, wherein forming the image further comprises determining, for each of a plurality of adjacent pixels, a unit vector normal to a surface of an object in the target scene based, at least in part, on a partial derivative of the depth differentials along two orthogonal directions.

17. The method of claim 14, wherein forming the image comprises determining at least one edge of an object in the target scene based on a spatial discontinuity in a depth of adjacent pixels.

18. The method of claim 14, wherein the light source comprises a pulsed laser.

19. The method of claim 14, wherein each photon detectors comprises a single photon avalanche diode (SPAD).

20. The method of claim 14, wherein each photon detector in the array of photon detectors is connected by a first FAD to a first neighboring photon detector in a first direction and by a second FAD to second neighboring photon detector in a second direction, wherein the first direction and the second direction are orthogonal to one another.

21. The method of claim 14, further comprising focusing, using an optical lens, photons reflected from the target scene onto the array of photon detectors.
